(19) United States
(12) Patent Application Publication
(10) Pub. No.: US 2005/0126698 A1
(43) Pub. Date: Jun. 16, 2005

(54) Production of dvd cards and other discs of noncircular shape

(76) Inventor: Ulrich Speer, Eisingen (DE)

Correspondence Address: Robert W Becker & Associates, Suite B, 707 Highway 66 East, Tijeras, NM, 87059, US

(21) Appl. No.: 10/509,534

(22) PCT Filed: Mar. 21, 2003
(86) PCT No.: PCT/EP03/02957

(30) Foreign Application Priority Data
Mar. 25, 2002 (DE) 102 13 273.9

(51) Int. Cl. B32B 31/00

(52) U.S. Cl. 156/285; 156/306.6; 156/556

(57) ABSTRACT

The invention relates to a device for assembling at least two noncircular substrates (1, 2) that have the same circumferential shape and that are provided with center holes (5, 6), especially for producing an optical data carrier. The aim of the invention is to provide a method and device with which the substrates can be assembled congruently and glued together flawlessly. For this purpose, the inventive device comprises a receiving unit (3) adapted to the center holes of the substrate, which receives the substrates (1, 2) so that they are spaced apart and rotatable about a common axis (8); an alignment device (10) for aligning the substrates (1, 2) with at least one stop (11); and a displacement unit for engaging the substrates with the stop. The invention also relates to a method for assembling substrates of the aforementioned kind.

The present invention relates to a device and to a method of joining at least two non-circular substrates which have the same peripheral shape and comprise inner holes, in particular for forming an optical data carrier, such as for example DVD cards.

Optical storage media have developed into being the preferred storage media and are to be found in a broad range of applications not only in computers but also in music and image reproducing devices. Such storage media are usually marketed in the form of circular disks having centered inner holes which are inserted into appropriate reading or writing devices in order to transfer data to the disks or to read-out data that is stored thereon.

Apart from CDs which are essentially composed of just a single substrate, DVDs have become a commonly marketed item and these consist of superimposed layers of substrates having respective storage areas and a greater storage density. To this end in the case of conventional circular DVD disks, at least two substrates in the form of round disks are joined together by means of adhesive. For this purpose, one known method of manufacturing a DVD uses a liquid adhesive which is applied to one of the substrates. The two substrates are then brought together and this composite assembly is thereafter centrifuged in common as is described in EP-A-0 833 315 for example. The liquid adhesive is thereby evenly distributed between the substrates due to the centrifugal forces produced by the centrifuging process. Surplus liquid adhesive emerges from the edges of the adhering substrates and can be removed. Furthermore, the requisite layer thickness of the adhesive is set by the centrifuging process. Subsequently, this DVD disk is irradiated with light for the purposes of hardening or curing the adhesive.

A further method of joining disk-shaped substrates is known from EP-A-0 855 703 wherein an adhesive film is used for joining the substrates.

In the case of CDs which are composed of just a single substrate, non-circular shapes have already been considered such as CDs having a card-like format for example and also CDs having fantasy shapes such as e.g. Christmas tree shapes and heart shapes which are not rotationally symmetric. For the production of a corresponding DVD card, two substrates of non-circular shape must be joined congruently. Hereby, the jointing techniques which are used for rotationally symmetrical substrate disks can cause problems in the case of rectangular formats (DVD cards) or fantasy formats (Christmas trees).

For example, the substrates do not rest securely on top of one another during the centrifuging of the adhesive when using the previously described known method of joining disk-shaped substrates with the aid of a liquid adhesive. In consequence, there is a misalignment of the substrates after the liquid adhesive is centrifuged. Consequently, the DVD substrates have to be realigned to restore congruency, an action which may destroy the adhesive layer of the liquid adhesive and introduce defects (e.g. bubbles) into the adhesive layer.

In the case of the previously mentioned EP-A-0 833 315, the circular substrates having an adhesive applied therebetween are placed on a projecting member with the aid of their centrally located inner holes, this member then being expanded for centering the two substrates whereby any misalignment is corrected.

Furthermore, reference should also be made to WO 86/05620 and EP 0 479 340 A2 both of which depict card-shaped or rectangular data carriers having circular data storage regions. In EP 0 479 340 A2, the information storage card is built-up from two substrates.

Consequently, the object of the present invention is to provide a device and a method of joining two non-circular substrates whereby the gluing process can be accomplished in an error free manner and the substrates are joined together in a congruent manner.

This object is achieved by a device and a method of joining at least two non-circular substrates having the same peripheral shape, in particular for forming an optical data carrier, in accordance with claim 1 and in accordance with claim 16 respectively.

The device in accordance with the invention comprises a receiving unit matched to the inner holes of the substrates for accommodating the substrates in mutually spaced and rotatable manner about a common axis, an aligning unit for aligning the substrates with at least one abutment member, and a displacement unit for moving the substrate outer edges of the substrates into engagement with the abutment member. The spaced substrates located on the receiving unit are brought into engagement with the abutment member by a relative movement, whereby they are rotated about the common axis and aligned congruently. Subsequently, they can then be joined to form a DVD card for example. The device is thus simple and flexible and can be adapted to the most diverse non-circular peripheral shapes of the substrates.

In one advantageous embodiment, the aligning unit comprises at least one counter abutment member. The abutment member and the counter abutment member align the substrates located between them on the receiving unit in a particularly precise manner.

The displacement unit can move the receiving unit, the abutment member and/or the counter abutment member in an advantageous manner and thus be adaptable to differing requirements in a flexible manner.

It is particularly advantageous if the receiving unit is moveable by the abutment member towards the counter abutment member. The substrates are thereby initially aligned in the direction of rotation by a first contact with the abutment member. Subsequently, the receiving unit is additionally moved together with the substrates accommodated thereon by the abutment member against the counter abutment member so as to ensure particularly precise alignment of the substrates.

In accordance with one advantageous aspect of the invention, the abutment member and/or the counter abutment member are matched to at least a part of a substrate edge of the substrates. Thus substrates having complicated peripheral shapes, such as the shape of a Christmas tree or a heart for example, can also be reliably aligned.

Furthermore it is of advantage if the abutment member and/or the counter abutment member comprise protrusions having abutment surfaces which point towards the substrates and are matched to at least a part of a substrate edge of the substrates, whereby the protrusions are spaced from one another by a distance which corresponds to the spacing between the substrates located on the receiving unit. The aligning unit can thereby be of lesser weight and thus the force required is reduced.

In accordance with a further advantageous aspect, the abutment member and/or the counter abutment member may comprise at least one cylinder whose longitudinal axis runs essentially parallel to the common axis of rotation. The cylinder or cylinders then only come into contact with the substrate edges at essentially point-like positions. Thus, firstly, tilting of the substrates can be prevented. Secondly, the use of cylinders is particularly advantageous since they can be matched to different shapes of substrates by virtue of a change of position.

In accordance with one advantageous embodiment, the receiving unit comprises a receiving pin incorporating an assembly for holding the substrates such that they are mutually spaced. The inner holes of the substrates can easily be centered relative to one another by means of such an arrangement and the rotational alignment process is effected on the receiving pin. After aligning the substrates, the substrates can then be pressed together on the receiving pin.

In accordance with one advantageous aspect, the assembly for holding the substrates in mutually spaced manner comprises moveable noses, moveable balls and/or spring rings which, for example, enter into the interior of the receiving pin when a suitable force is applied so that the substrates can be pressed together.

Furthermore, the receiving unit could comprise at least two separate receiving pins which accommodate the substrates separately. The substrates can then be fed in advantageous manner to the processes occurring on the individual receiving pins, such as an adhesive coating process for example.

In advantageous manner, the device additionally comprises yet another unit for applying an adhesive to at least one of the substrates. The adhesive does not then have to be applied in a separate process step.

If the adhesive is an adhesive film, this is particularly advantageous because the device will not be sullied by centrifuged liquid adhesive when the substrates are being joined together.

Provision may be made in advantageous manner for a joining unit for pressing the substrates together. Finally, it is also of advantage, if a vacuum chamber is provided wherein the substrates on the receiving unit are accommodated. Defects in the adhesive or interconnecting layer between the two substrates can be prevented by joining them in a vacuum.

The method in accordance with the invention comprises the following steps: 1) arranging the substrates on a receiving unit matched to the inner holes in such a manner that they are spaced and rotatable about a common axis; 2) aligning the substrates by engaging the substrate outer edges with at least one abutment member and rotating the substrates about the common axis; and 3) joining the substrates. In accordance with one advantageous aspect of the method, the rotation of the substrates is effected by engaging the substrates with at least one abutment member and/or a counter abutment member. The advantages of the method in accordance with the invention correspond to the previously mentioned advantages in regard to the device in accordance with the invention.

Further features, advantages and details of the invention are discussed hereinafter on the basis of preferred exemplary embodiments taken with reference to the Figures. Therein:

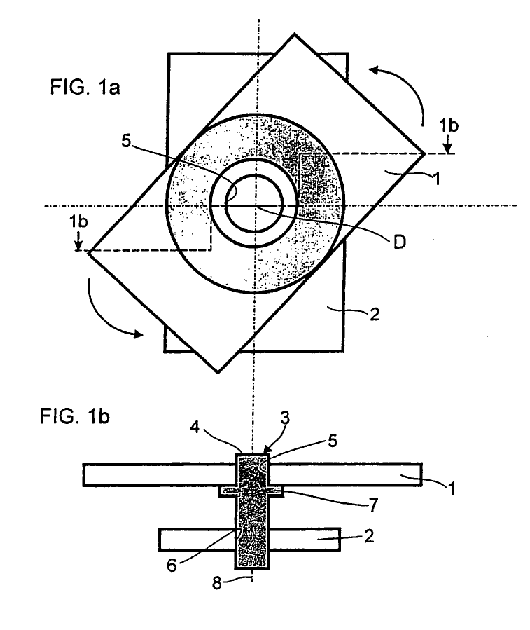

FIG. 1a shows a plan view of two substrates for a DVD card accommodated on a preferred embodiment of a receiving unit;

FIG. 1b a schematic sectional view along the line 1b-1b in FIG. 1a;

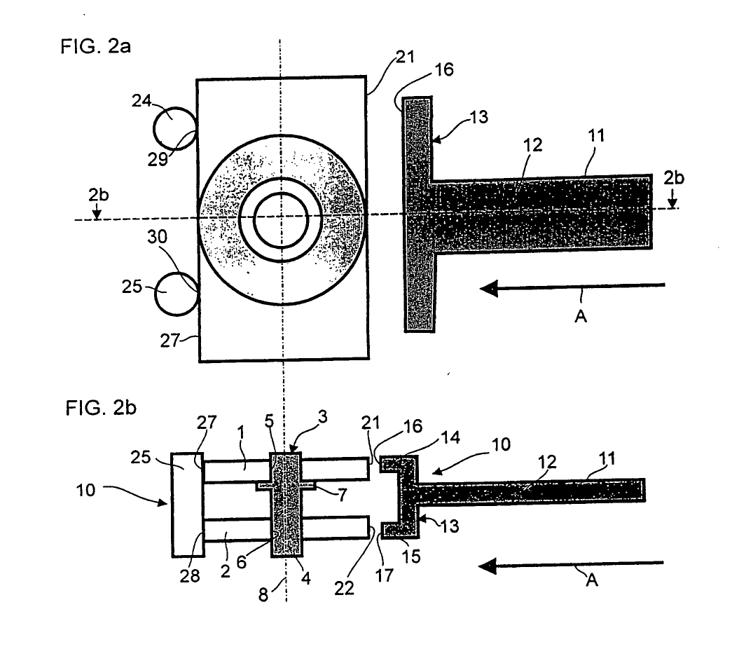

FIG. 2a a schematic plan view of a device in accordance with a first embodiment of the invention;

FIG. 2b a schematic sectional view of the device in FIG. 2a along the line 2b-2b in FIG. 2a;

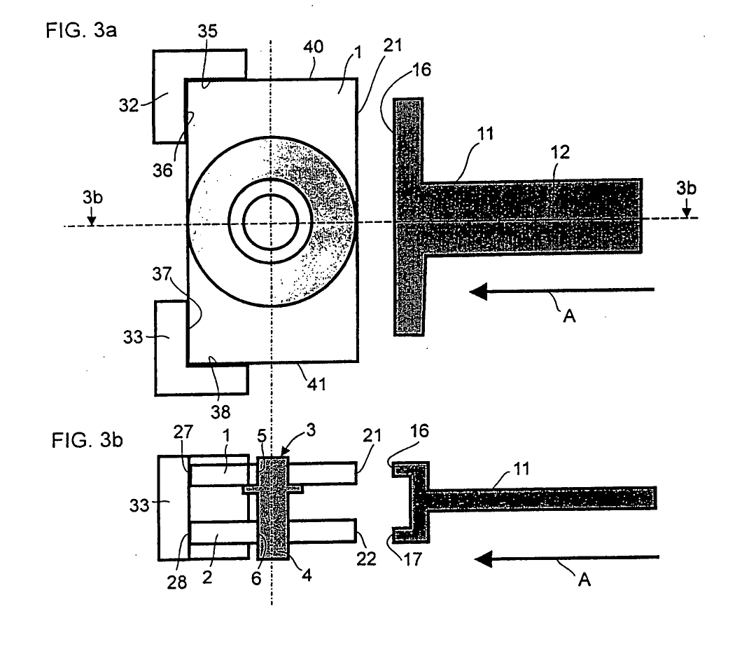

FIG. 3a a schematic plan view of a device in accordance with a second embodiment of the invention;

FIG. 3b a schematic sectional view of the device in FIG. 3a along the line 3b-3b in FIG. 3a;

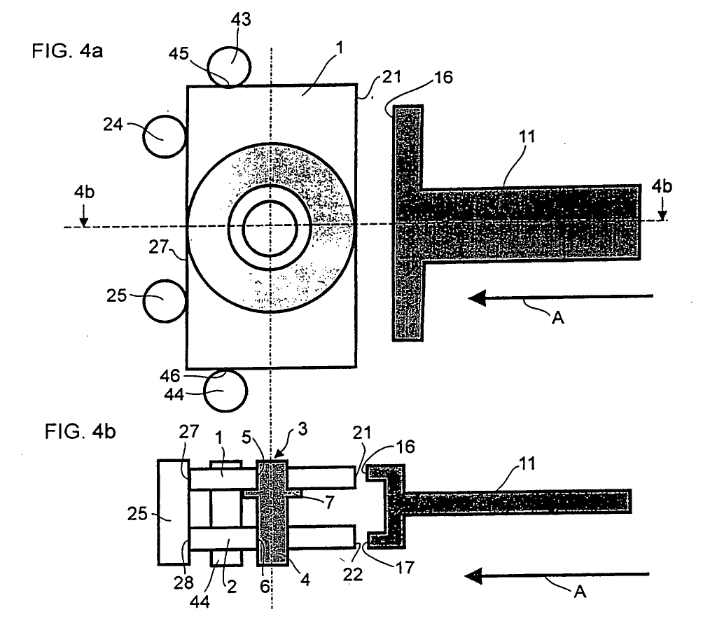

FIG. 4a a schematic plan view of a device in accordance with a third embodiment of the invention;

FIG. 4b a schematic sectional view of the device in FIG. 4a along the line 4b-4b in FIG. 4a;

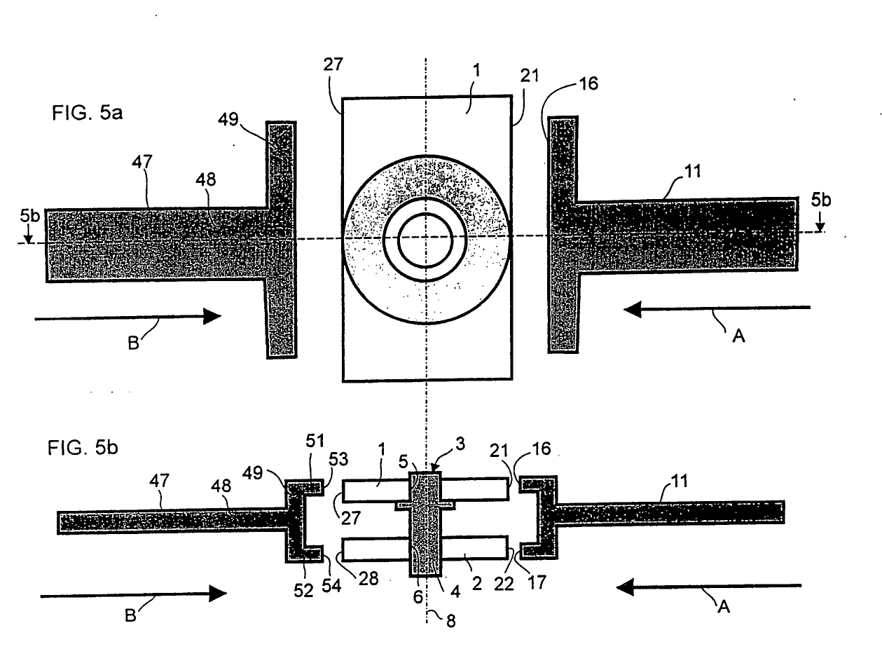

FIG. 5a a schematic plan view of a device in accordance with a fourth embodiment;

FIG. 5b a schematic sectional view of the device in FIG. 5a along the line 5b-5b in FIG. 5a;

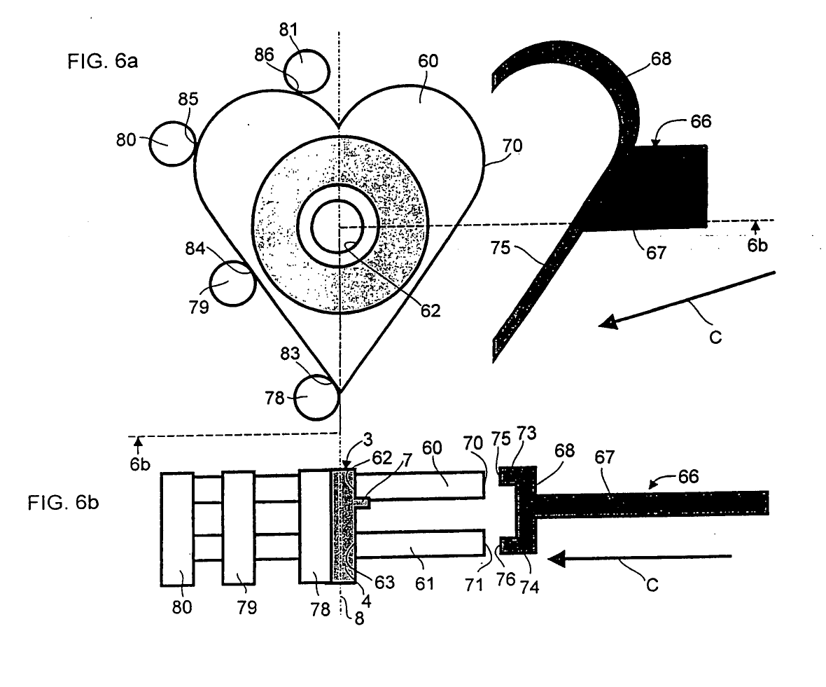

FIG. 6a a schematic plan view of a device in accordance with a fifth embodiment of the invention; and

FIG. 6b a schematic sectional view of the device in FIG. 6a along the line 6b-6b in FIG. 6a.

FIG. 1a shows schematically two substrates 1 and 2 of rectangular shape which are arranged one above the other and have round data storage parts formed in the central region thereof. The two substrates 1 and 2 are also referred to as DVD Halfsides which are to be joined together for the purposes of forming a DVD card. As is indicated by the arrows in FIG. 1a, the two substrates 1 and 2 are arranged such as to be rotatable about a common axis of rotation D which runs through the middle of the data storage parts.

A preferred embodiment of a receiving or seating unit 3 for use in the device or the method in accordance with the invention is shown schematically in FIG. 1b. The two substrates 1 and 2 shown in FIG. 1a are arranged on the receiving unit 3 so that they are spaced and rotatable about the common axis of rotation D. To this end, the receiving unit 3 comprises a cylindrical pin 4 which is formed in such a manner that the two substrates 1 and 2 are held in mutually spaced and rotatable manner thereon. The outer diameter of the pin 4 is matched to the inner holes 5 and 6 of the substrates 1 and 2 in order to accommodate them in a centered manner. For the purposes of maintaining a pre-determined spacing between the substrates 1 and 2, a moveable protrusion 7 is provided on the receiving unit 3 in the preferred embodiment. The common axis of rotation D of the two substrates 1 and 2 is defined by the central axis 8 of the pin 4.

In the method in accordance with invention, the aligned substrates are preferably pressed together on the receiving unit 3 by a not shown joining unit. The protrusion 7 has a first position in which, for example, the substrate 1 is placed thereon, and a second position in which movement of the substrate 1 towards the substrate 2 is made possible. Thus, for the purposes of joining the substrates 1 and 2 for example, the protrusion 7 can be retracted into the interior of the pin in a controllable manner so that the upper substrate 1 can be applied to the lower substrate 2 and be connected thereto by means of a suitable pressure.

Although the protrusion 7 is only shown schematically in the Figures, it is clear that it could be implemented in the form of a moveable nose, in the form of moveable balls or by means of spring rings. Furthermore, a pin or distancing pin especially suitable for accommodating the substrates in a precisely centered manner such as is described in the published German specification DE 199 27 514 A1, and to which reference is hereby made so as to avoid repetition, can be used to advantage in the invention.

Alternatively however, rather than the one-piece pin 4, the receiving unit could comprise at least two receiving pins upon which, for example, the substrates are initially separately accommodated in order to be subjected to different processes. The receiving pins are centered relative to one another in a suitable manner for the joining process. For example, they could have complementary shapes and be brought into engagement with one another for the purposes of aligning the substrates. The subsequent process of joining the substrates can then be effected on the mutually centered receiving pins.

The preferred embodiments of the device in accordance with the invention shown in FIGS. 2a to 6b each comprise the receiving unit 3 depicted in FIG. 1b. Furthermore, they each comprise an aligning unit and a not shown displacement unit for moving the elements of the aligning unit and/or the receiving unit. The directions of movement of the corresponding elements are indicated in the Figures by arrows. In order to avoid repetitions, the same reference symbols are used in the Figures for the same or equivalent elements.

An aligning unit in a first exemplary embodiment of the device in accordance with the invention, which is schematically shown in FIGS. 2a and 2b, comprises an abutment member 11 which is moved by a not shown displacement unit in the direction of the arrow A in FIGS. 2a and 2b. The receiving unit 3 of this exemplary embodiment is moveable.

The abutment member 11 has a shaft 12 which extends in the direction of movement of the arrow A and is formed at the end thereof pointing towards the substrate with an edge seating or abutment member 13 that extends transversely of the shaft. The edge abutment member 13 has two protrusions 14 and 15 whose end faces pointing towards the substrates form abutment edges 16 and 17 which are adapted to be moved into engagement with the respective substrate edges 21 and 22 of the substrates 1 and 2 as can best be perceived in FIG. 2b. The protrusions 14 and 15 are spaced from one another by a distance which corresponds to the spacing maintained by the protrusion 7 between the substrates 1 and 2 on the receiving unit 3. Thus, the abutment edges 16 and 17 essentially only come into engagement with the substrate edges 21 and 22, whereby the abutment edges 16 and 17 have a shape that is complementary to that of at least a part of the substrate edges 21 and 22 of the substrates 1 and 2. In the embodiment shown with the rectangular substrates 1 and 2 this means that the abutment edges 16 and 17 are planar and run vertically. Furthermore, the aligning unit 10 comprises a counter abutment member which incorporates two cylindrical pins 24 and 25 in the embodiment of FIGS. 2a and 2b, said pins coming into contact with the substrate edges 27 and 28 of the two substrates at the points 29 and 30 for the purposes of aligning the two substrates 1 and 2.

In order to join the two rectangular substrates 1 and 2 so as to form a DVD card, they are initially accommodated by means of the inner holes 5 and 6 on the pin 4, whereby the distance between the two substrates 1 and 2 that is maintained by the pin 4 corresponds to the spacing between the two protrusions 14 and 15 of the abutment member 11. In general, the two substrates 1 and 2 are not usually aligned congruently above one another at this time point. Furthermore, the receiving unit 3 is at a distance from the pins 24, 25 at the point in time at which the substrates 1 and 2 are being seated, that the substrates 1 and 2 will preferably not come into contact therewith. The abutment member 11 is subsequently moved by the displacement unit toward the substrates 1 and 2 until the abutment edges 16 and 17 come into engagement with the substrate edges 21 and 22.

The displacement unit continues the movement of the abutment member 11 so that it presses against the substrate edges 21 and 22. This produces a rotational movement of the substrates 1 and 2 on the pin 4 until the abutment edges 16 and 17 rest completely against the substrate edges 21 and 22 and the latter are arranged congruently in a plan view. At this time point, the two substrates 1 and 2 are essentially aligned on the receiving unit 3. In the course of further movement of the abutment member 11 against the substrates 1 and 2, the latter are moved together with the receiving unit 3 towards the fixed pins 24 and 25. Perfect alignment is obtained when the substrate edges 27 and 28 of the substrates 1 and 2 finally rest against the points 29 and 30 of the pins 24 and 25.

Alternatively however, the receiving unit 3 could be fixed whereby the process of aligning the substrates 1 and 2 is effected entirely by the movement of the abutment member 11.

FIGS. 3a and 3b show a further embodiment of the device in accordance with the invention. The device shown in FIGS. 3a and 3b is designed especially for joining rectangular substrates 1 and 2. In like manner to the preceding embodiment, the substrates 1 and 2 are accommodated in spaced and rotatable manner on a pin 4. An aligning unit in the embodiment of FIGS. 3a and 3b comprises an abutment member 11 which is moveable in the direction of the arrow A by a not shown displacement unit and which incorporates abutment edges 16 and 17 that are brought into engagement with the substrate edges 21 and 22 of the rectangular substrates 1 and 2. In this embodiment too, a receiving unit 3 is moveable together with the substrates 1 and 2 and they are moved by the abutment member 11 in the direction of a counter abutment member which comprises two fixed counter abutment members 32 and 33. The two fixed counter abutment members 32 and 33 possess walls 35, 36, 37 and 38. When the abutment member 11 presses the receiving unit 3 together with the substrates 1 and 2 towards the counter abutment member, the walls 36 and 37 come into engagement with the long substrate edges 27 and 28 of the substrates 1 and 2. The walls 35 and 38 however come to rest on the short substrate edges 40 and 41, this being particularly helpful in regard to precise alignment of the rectangular substrates 1 and 2.

In the exemplary embodiment of FIGS. 4a and 4b, a counter abutment member comprises further fixed cylindrical pins 43 and 44 in addition to the cylindrical pins 24 and 25 which were also provided in the embodiment of FIGS. 2a and 2b, said further cylindrical pins coming to rest on the short substrate edges 40 and 41 of the substrates 1 and 2 at the points 45 and 46 so that they are particularly advantageous for aligning the substrates 1 and 2, especially those having a rectangular shape. In comparison with the exemplary embodiment of FIGS. 3a and 3b however, there is a greater freedom of choice in regard to the selection of the peripheral shape of the finally joined DVD cards in the device in accordance with FIGS. 4a and 4b.

In FIGS. 5a and 5b, there is shown an embodiment of the device in accordance with the invention wherein a receiving unit 3 is fixed and an abutment member 11 of an aligning unit is moved by a not shown displacement unit in the direction of the arrow A. The abutment edges 16 and 17 of the abutment member 11 are thereby brought into engagement with the substrate edges 21 and 22 of the substrates 1 and 2 for producing a rotary aligning movement of the substrates.

Furthermore, the aligning unit of the embodiment of FIGS. 5a and 5b comprises a moveable counter abutment member 47 which comprises a shaft 48 and an edge abutment member 49 that is arranged on the end of the shaft 48 pointing towards the receiving unit 3. The edge abutment member 49 has abutment edges 53 and 54 which are formed on the protrusions 51 and 52.

The counter abutment member 47 is, as it were, the mirror image of the abutment member 11 and is arranged on the opposite side of the substrates 1 and 2 from the abutment member 11. Like the abutment member 11, the counter abutment member 47 is moved by the not shown displacement unit toward the substrate edges 27 and 28 of the rectangular substrates 1 and 2 in the direction of the arrow B until the abutment edges 53 and 54 eventually come into engagement with the substrate edges 27 and 28 of the substrates 1 and 2. Due to this movement of the two abutment members 11 and 47 towards one another and against the substrates 1 and 2 arranged in rotatable manner on the fixed receiving unit 3, the rectangular substrates are aligned congruently and can then be joined together to form a DVD card.

FIGS. 6a and 6b show a further exemplary embodiment of the device in accordance with the invention which comprises an aligning unit matched to a fantasy shape. Two heart-shaped substrates 60 and 61 are to be joined to form a DVD which is intended as a Valentine Card or some other form of gift article for example. The two heart-shaped substrates 60 and 61 are accommodated by means of their inner holes 62 and 63 in spaced and rotatable manner on a pin 4 of a moveable receiving unit 3. An abutment member 66 comprises a shaft 67 and an edge abutment member 68 which is arranged at the end of the shaft pointing towards the substrates. The abutment member 66 is moved toward the substrates 60 and 61 in the direction of the arrow C by a not shown displacement unit. The edge abutment member 68 is matched to the substrate edges 70 and 71 of the heart-shaped substrates 60 and 61. In particular, the edge abutment member 68 comprises two protrusions 73 and 74 having abutment edges 75 and 76 formed at the ends thereof.

The edge abutment member 68 is formed in such a manner that it can encompass the substrate edges 70 and 71 of the heart-shaped substrates 60 and 61. To this end, the edge abutment member 68 is preferably somewhat resilient so that it grasps the substrate edges 70 and 71, as it were, and thus comes into engagement therewith by virtue of the movement of the abutment member 66 in the direction of the arrow C. Due to the further movement of the abutment member 66 against the substrates 60 and 61 accommodated on the receiving unit 3, the receiving unit 3 is moved towards a fixed counter abutment member which comprises cylindrical abutment pins 78, 79, 80 and 81 that come to rest at the points 83, 84, 85 and 86 on those substrate edges of the substrates which are opposite the substrate edges 70 and 71.

As has already been indicated, the counter abutment members can be omitted in a modification of the exemplary embodiments described hereinbefore. The receiving unit 3 is then fixed and the abutment member 11 or 66 is moved against the substrate edges of the substrates. Furthermore, the moveable abutment member could comprise, in like manner to the counter abutment members in the embodiments of FIGS. 2a, 2b, 4a, 4b, 6a, 6b, one or more moveable cylindrical pins which are arranged such that their cylindrical axes are parallel to the common axis of rotation D, namely, transverse to the substrate edges, and only come into contact with the substrates in point-like manner. This enables there to be a large degree of flexibility when processing different shapes of substrates since a abutment member consisting of cylindrical pins can easily and quickly be matched to any arbitrary shape of the substrates by suitable movement or positioning of the pins. The moveable pins can be arranged at one side of the substrates or around the substrates.

The two substrates are joined congruently after they have been aligned. To this end and even before the substrates are aligned for example, there is applied to a joining side of at least one of the substrates an adhesive which may, for example, be a liquid adhesive film produced by centrifuging, an adhesive film which consists of just one adhesive layer without a backing material, or an adhesive film on a backing material. The device may comprise a unit that is suitable for applying the adhesive.

The process of joining the substrates is preferably effected in a vacuum chamber since defects in the jointing layer between the substrates, such as trapped bubbles in the adhesive for example, can thereby be prevented.

The jointing unit provided for the process of pressing the substrates together can be a cylinder station or a membrane station. An example of such a membrane station is described in the applicant's unpublished patent application DE 101 00 427 which is incorporated herein by reference so as to avoid repetition. Such a membrane station is particularly suitable for use in a vacuum chamber.

The device and the method in accordance with the invention thus enable non-circular optical data carriers consisting of at least two substrates to be produced, whereby precise alignment and secure joining of the substrates is attained by simple measures even in the case of complicated peripheral shapes.

1-20. (canceled)

21. A device for joining at least two non-circular substrates that have inner holes and the same peripheral shape, comprising:
a receiving unit adapted to said inner holes of said substrates for receiving said substrates in a spaced-apart manner, wherein said receiving unit furthermore receives said substrates such that they are rotatable about a common axis;
an aligning unit 10 for aligning said substrates wherein said aligning unit is provided with at least one abutment member 11, 66 and at least one counter abutment member; and
a displacement means for bringing outer edges of said substrates into engagement with said at least one abutment member and said at least one counter abutment member.

22. A device according to claim 21, wherein said displacement means moves at least one of said receiving unit 3, said at least one abutment member and said at least one counter abutment member;

23. A device according to claim 21, wherein said receiving unit is movable in a direction toward said at least one counter abutment member by said at least one abutment member.

24. A device according to claim 21, wherein the shape of at least one of said at least one abutment member and said at least one counter abutment member is adapted to at least a portion of said outer edges of said substrates.

25. A device according to claim 21, wherein at least one of said at least one abutment member and said at least one counter abutment member is provided with protrusions having abutment surfaces that face said receiving unit and are adapted to at least a portion of said outer edges of said substrate that are to be joined, and wherein said protrusions have a spacing relative to one another that corresponds to the spacing at which said substrates are spaced-apart on said receiving unit.

26. A device according to claim 21, wherein at least one of at least one abutment member and said at least one counterabutment member is provided with a cylinder having a longitudinal axis that extends essentially parallel to said common axis.

27. A device according to claim 21, wherein said receiving unit is provided with a receiving pin having a means for holding said substrates in a spaced-apart manner.

28. A device according to claim 27, wherein said means for holding said substrates in a spaced-apart manner comprises at least one of movable noses, movable balls, and spring rings.

29. A device according to claim 21, wherein said receiving unit is provided with at least two separate receiving pins.

30. A device according to claim 21, which further comprises means for applying an adhesive to at least one of said substrates.

31. A device according to claim 30, wherein said adhesive is an adhesive film.

32. A device according to claim 21, which further comprises a joining unit for pressing said substrates together.

33. A device according to claim 21, wherein a vacuum chamber is provided.

34. A method of joining at least two non-circular substrates that have inner holes and the same peripheral shape, said method including the steps of
disposing said substrates on a receiving unit, which is adapted to said inner holes of said substrates, in such a way that said substrates are spaced-apart and are held so as to be rotatable about a common axis;
aligning said substrates by bringing outer edges of said substrates into engagement with at least one abutment member and at least one counter abutment member wherein said aligning step is effected by rotation of said substrates about said common axis; and
joining said substrates together.

35. A method according to claim 34, which includes the further step of applying an adhesive to at least one of said substrates.

36. A method according to claim 35, wherein said adhesive is an adhesive film.

37. A method according to claim 34, wherein said step of joining said substrates together is effected by pressing said substrates together.

38. A method according to claim 34, wherein said aligning and joining steps are effected in a vacuum.
